(19) United States
(12) Patent Application Publication
(10) Pub. No.: US 2024/0329311 A1
(43) Pub. Date: Oct. 3, 2024

(54) METHOD FOR MANUFACTURING OPTICAL WAVEGUIDE AND OPTICAL WAVEGUIDE

(71) Applicants: Beijing Zitiao Network Technology Co., Ltd., Beijing (CN); LEMON INC., GRAND CAYMAN (KY)

(72) Inventors: Wen XIONG, Beijing (CN); Peng ZHANG, Los Angeles, CA (US); Wei TAN, Beijing (CN); Hao TANG, Beijing (CN)

(21) Appl. No.: 18/617,623

(22) Filed: Mar. 26, 2024

(30) Foreign Application Priority Data
Mar. 28, 2023 (CN) 202310318190.0

(51) Int. Cl. G02B 6/136; G02B 6/124

(52) U.S. Cl. CPC G02B 6/136; G02B 6/124

(57) ABSTRACT

The embodiments of the present disclosure provide a method for manufacturing an optical waveguide and an optical waveguide, the method for manufacturing includes: providing a substrate; forming a first thin film layer, a second thin film layer and a sacrificial layer on the substrate in a stacked manner, a refractive index of the first thin film layer is larger than 2; exposing and developing the sacrificial layer so that the sacrificial layer forms a first mask layer; etching the second thin film layer by taking the first mask layer as mask so that the second thin film layer forms a second mask layer; removing the first mask layer, and etching the first thin film layer by taking the second mask layer as mask so that the first thin film layer forms a grating layer; and removing the second mask layer to form the optical waveguide comprising the grating layer and the substrate.

### CROSS REFERENCE TO RELATED APPLICATION

This application claims priority from Chinese Patent Application No. 202310318190.0, filed on Mar. 28, 2023, the contents of which are hereby incorporated by reference in their entirety for all purposes.

### TECHNICAL FIELD

The embodiment of the disclosure relates to the technical field of optics, in particular to a method for manufacturing an optical waveguide and an optical waveguide.

### BACKGROUND

Augmented Reality (AR) glasses based on optical waveguides are one of the AR glasses with wide application prospects. The optical waveguide has the advantages of small structure, light weight, strong optical function and the like, so that the optical waveguide is one of core devices for realizing portable AR glasses. The optical waveguide comprises a substrate and a grating layer, light emitted by the optical machine is coupled into the substrate through the grating layer, light is transmitted by total internal reflection, and then coupled out through the grating layer until the light is transmitted to human eyes, so that the human eyes can observe images displayed by the optical machine.

In the related art, the AR glasses use a micro light emitting diode (micro LED for short) display screen to display. The method for manufacturing the optical waveguide comprises the steps of providing a substrate, disposing nanoimprint lithography glue on the substrate, and directly forming a grating layer on the nanoimprint lithography glue by nanoimprint lithography.

### SUMMARY

The embodiment of the present disclosure provides a method for manufacturing an optical waveguide and an optical waveguide.

In one aspect, the embodiment of the present disclosure provides a method for manufacturing an optical waveguide, comprising:
providing a substrate;
forming a first thin film layer, a second thin film layer and a sacrificial layer on the substrate in a stacked manner, wherein a refractive index of the first thin film layer is larger than 2;
exposing and developing the sacrificial layer so that the sacrificial layer forms a first mask layer;
etching the second thin film layer by taking the first mask layer as mask so that the second thin film layer forms a second mask layer;
removing the first mask layer, and etching the first thin film layer by taking the second mask layer as mask so that the first thin film layer forms a grating layer, wherein the grating layer comprises a plurality of skewed tooth gratings, slant angles of all the skewed tooth gratings relative to the substrate are equal, and heights of all the skewed tooth gratings are equal; and
removing the second mask layer to form the optical waveguide comprising the grating layer and the substrate.

In another aspect, the embodiment of the present disclosure provides an optical waveguide comprising a substrate and a grating layer, the grating layer is disposed on the substrate and comprises a plurality of skewed tooth gratings, slant angles of all the skewed tooth gratings relative to the substrate are equal, and heights of all the skewed tooth gratings are equal; and
refractive index of the grating layer is greater than 2.

### BRIEF DESCRIPTION OF THE DRAWINGS

In order to more clearly illustrate the embodiments of the present disclosure or the technical solutions in the related art, the drawings used in the embodiments or the description of the related art will be briefly described below, and it is obvious that the drawings in the following description are some embodiments of the present disclosure, and those skilled in the art can obtain other drawings without paying creative effort.

FIG. 1 is a diagram illustrating diffraction efficiency of red light in a related art;

FIG. 2 is a process flow diagram of a method of fabricating an optical waveguide provided by an embodiment of the present disclosure;

FIG. 3 is a schematic structural diagram of a substrate in a method for manufacturing an optical waveguide provided by an embodiment of the present disclosure;

FIG. 4 is a schematic structural diagram of a first thin film layer and a second thin film layer formed in a method for manufacturing an optical waveguide provided by an embodiment of the present disclosure;

FIG. 5 is a schematic structural diagram of a sacrificial layer formed in a method for manufacturing an optical waveguide provided by an embodiment of the present disclosure;

FIG. 6 is a schematic structural diagram of a first mask layer formed by a sacrificial layer in a method for manufacturing an optical waveguide provided by an embodiment of the present disclosure;

FIG. 7 is a schematic structural diagram illustrating a second mask layer formed by a second thin film layer in the method for manufacturing an optical waveguide provided by the embodiment of the present disclosure;

FIG. 8 is a schematic structural diagram of a grating layer formed in a manufacturing method of an optical waveguide provided by an embodiment of the present disclosure;

FIG. 9 is a diagram illustrating diffraction efficiency of red light provided by an embodiment of the present disclosure;

FIG. 10 is a graph showing the diffraction efficiency of green light provided by an embodiment of the present disclosure;

FIG. 11 is a schematic diagram of diffraction efficiency of blue light provided by an embodiment of the present disclosure.

### DETAILED DESCRIPTION

To make the objects, technical solutions and advantages of the embodiments of the present disclosure more apparent, the technical solutions in the embodiments of the present disclosure will be described clearly and completely with reference to the drawings in the embodiments of the present disclosure, and it is obvious that the described embodiments are some, but not all embodiments of the present disclosure. All the other embodiments, which can be derived by a person skilled in the art from the embodiments disclosed herein paying creative effort, are intended to be within the scope of the present disclosure.

It should be noted that the terms “first” and “second” are used for descriptive purposes only and are not to be construed as indicating or implying relative importance or to implicitly indicate the number of technical features indicated. Thus, a feature defined as “first” or “second” may explicitly or implicitly include at least one of the feature. In the description of the embodiments of the present disclosure, “a plurality” means at least two, e.g., two, three, etc., unless explicitly specified otherwise.

In the embodiments of the present disclosure, unless otherwise explicitly stated or limited, the terms “mounted”, “connected”, “fixed” and the like are to be construed broadly, e.g., as being fixedly connected, detachably connected, or integrated; may be mechanically coupled, may be electrically coupled or may be in communication with each other; may be directly connected or indirectly connected through intervening media, or may be interconnected within two elements or in a relationship where two elements interact with each other unless otherwise specifically limited. Specific meanings of the above terms in the disclosed embodiments can be understood by those of ordinary skill in the art according to specific situations.

In the embodiments of the present disclosure, unless otherwise explicitly specified or limited, a first feature “on” or “under” a second feature may be the first feature directly contacting the second feature, or the first and second features being indirectly contacting with each other through an intermediate media. Also, a first feature “on”, “above”, and “over” a second feature may be the first feature being directly on or obliquely above the second feature, or simply means that the first feature is at a higher level than the second feature. A first feature “under”, “beneath”, and “below” a second feature may be the first feature being directly under or obliquely under the second feature, or may simply mean that the first feature is at a level lower than the second feature.

In the description above, the descriptions with references to the terms “one embodiment”, “some embodiments”, “an example”, “a specific example”, “some examples” and the like are intended to mean that a particular feature, structure, material, or characteristic described in connection with the embodiment or example is included in at least one embodiment or example of the embodiments of the present disclosure. In this specification, the schematic representations of the terms used above are not necessarily intended to refer to the same embodiment or example. Furthermore, the particular features, structures, materials, or characteristics described may be combined in any suitable manner in any one or more embodiments or examples. Moreover, various embodiments or examples and features of various embodiments or examples described in this specification can be combined and combined by one skilled in the art without being mutually inconsistent.

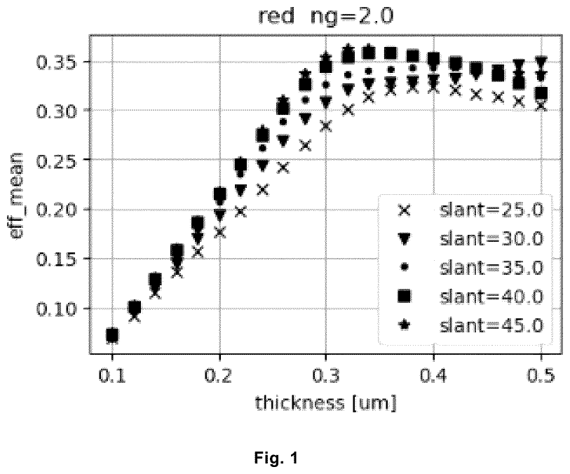

As described in the background art, in the display process of the AR glasses in the related art, the diffraction efficiency of a part of light of a specific color in the grating layer of the optical waveguide is low, and there is a problem of low brightness of the light of the specific color. The inventor's research found that the reason for this problem is that in the related technologies, nanoimprint lithography glue materials are used to form the grating layer, and the refractive index of the nanoimprint lithography glue does not exceed 2, resulting in low diffraction efficiency of light of a specific color. For example, the light of a specific color is red light, and the maximum diffraction efficiency of red light emitted from the grating layer does not exceed 36%. Specifically, referring to FIG. 1, the abscissa in FIG. 1 is the thickness of the grating layer in the unit of μm; the ordinate is the diffraction efficiency; “red” represents red light, “ng=2” represents that the refractive index of the grating layer is 2; and “slant” is the slant angle of the skewed tooth grating of the grating layer. FIG. 1 has given five slant angles, which are 25 degrees, 30 degrees, 35 degrees, 40 degrees, and 45 degrees respectively. When the refractive index of the grating layer is 2, it can be known from the simulation shown in FIG. 1 that the maximum diffraction efficiency of red light emitted from the grating layer does not exceed 36%.

In order to solve the above problem, embodiments of the present disclosure provide a method for manufacturing an optical waveguide and an optical waveguide, where a semiconductor etching technology is used in the method for manufacturing an optical waveguide. A grating layer with a refractive index greater than 2 is formed on a substrate, so that the refractive index of the grating layer is greater than 2, and a nanoimprint lithography glue is abandoned, so that the diffraction efficiency of light of a specific color can be improved by optimizing the structure of the grating layer of the optical waveguide, and further, the brightness of the light of a specific color can be improved.

The method for manufacturing the optical waveguide and the optical waveguide provided by the embodiments of the present disclosure will be described in detail below with reference to specific examples.

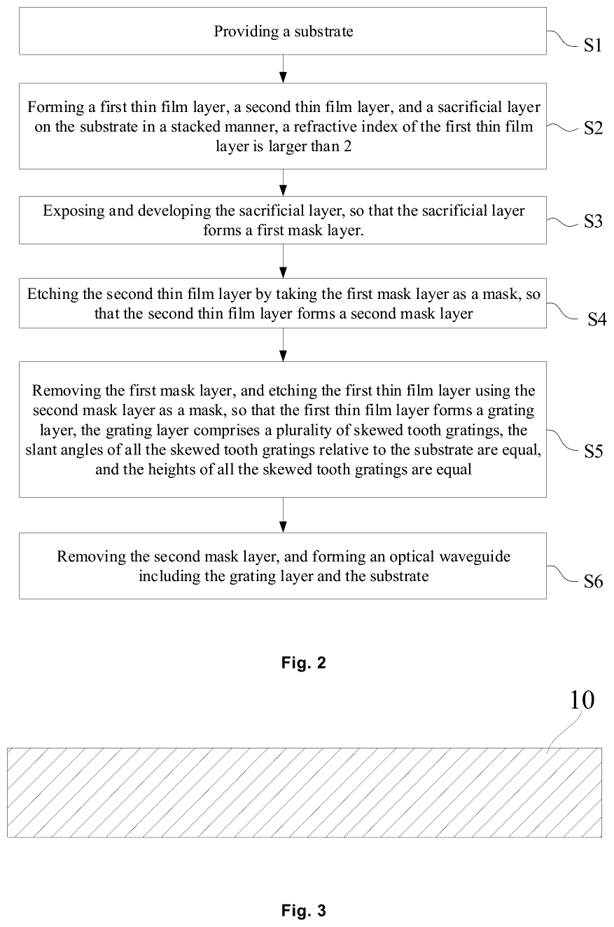

As shown in FIG. 2, an embodiment of the present disclosure provides a method for manufacturing an optical waveguide, including:
step S1: providing a substrate 10.

Illustratively, as shown in FIG. 3, the substrate 10 may provide a support for the grating layer of the optical waveguide, and the substrate 10 allows total reflection of light within the substrate 10. The substrate 10 may be a glass substrate, and the refractive index of the substrate 10 may be set as needed. For example, the refractive index of the substrate 10 is greater than or equal to 2, and the thickness of the substrate 10 may be 0.1-3 mm.

Step S2: forming a first thin film layer 11, a second thin film layer 12, and a sacrificial layer 13 on the substrate 10 in a stacked manner.

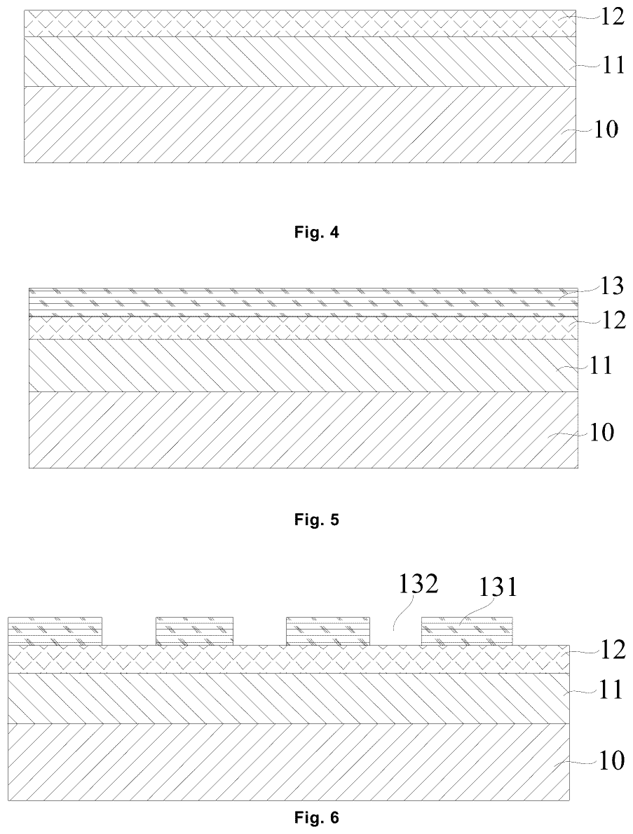

FIGS. 4 and 5 show a structure in which the first thin film layer 11, the second thin film layer 12, and the sacrificial layer 13 are formed on the substrate 10.

The refractive index of the first thin film layer 11 may be greater than 2. In some examples, the refractive index of the first thin film layer 11 is greater than 2 and less than or equal to 3. The material of the first thin film layer 11 may be one of TiO₂, SiN₄, HfO₂, Ta₂O₅, ZrO₂, and the like. In the present embodiment, the material of the first thin film layer 11 is TiO₂.

The thickness of the first thin film layer 11 refers to the height of the first thin film layer 11 in the direction perpendicular to the substrate 10. The thickness of the first thin film layer 11 can be 0.05-0.5 μm.

The method of forming the first thin film layer 11 may include, but is not limited to: Physical Vapor Deposition (PVD), Chemical Vapor Deposition (CVD), and Atomic Layer Deposition (ALD). In some examples, the first thin film layer 11 is formed by evaporation in physical vapor deposition. Specifically, TiO₂ powder is used as an evaporation source, TiO₂ powder is heated by an evaporator in a vacuum atmosphere to sublimate into an evaporation particle flow, and the evaporation particle flow is emitted toward the substrate 10 to deposit and form the first thin film layer 11 on the substrate 10.

The material of the second thin film layer 12 may be chromium (Cr). The method of forming the second thin film layer 12 may include, but are not limited to: Physical Vapor Deposition, Chemical Vapor Deposition, or Atomic Layer Deposition. In some examples, the second thin film layer 12 is formed using physical vapor deposition. Specifically, Cr powder is used as the material source, and the Cr power is gasified into gaseous atoms, molecules or partially ionized into ions under vacuum conditions and is conveyed to the surface of the first thin film layer 11 away from the substrate 10 through low pressure gas, so that it is deposited on the surface of the first thin film layer 11 to form the second thin film layer 12.

The thickness of the second thin film layer 12 refers to the height of the second thin film layer 12 in a direction perpendicular to the substrate 10.

The sacrificial layer 13 may be a photoresist layer or a resist layer, and the sacrificial layer 13 may be formed by a coating technique. In some examples, the sacrificial layer 13 is formed by spin coating. Specifically, the substrate 10 on which the second thin film layer 12 is formed is placed on a horizontal rotation table, a photoresist solvent is injected into the central region of the second thin film layer 12, the horizontal rotation table is rotated from slow to fast, and the photoresist solvent on the second thin film layer 12 is coated to the surface of the second thin film layer 12 away from the substrate 10 by centrifugal force to form the sacrificial layer 13.

In an alternative embodiment, as shown in FIGS. 4 and 5, the first thin film layer 11 is formed on the substrate 10 by physical vapor deposition, the second thin film layer 12 is formed on the first thin film layer 11 by physical vapor deposition, and the sacrificial layer 13 is formed on the second thin film layer 12 by spin coating, wherein the first thin film layer 11, the second thin film layer 12 and the sacrificial layer 13 are sequentially arranged from bottom to top along a direction perpendicular to the substrate 10.

Step S3: exposing and developing the sacrificial layer 13, so that the sacrificial layer 13 forms a first mask layer.

The first mask layer is typically formed as follows: the sacrificial layer 13 is exposed and developed with the mask plate as a mask to form a first mask layer. As shown in FIG. 6, the first mask layer has a plurality of first light-transmitting openings 132 and a plurality of first mask bosses 131 separating the plurality of first light-transmitting openings 132.

The sacrificial layer 13 may be exposed by an electron beam. In another method, the sacrificial layer 13 may be exposed to deep ultraviolet light or extreme ultraviolet light.

Step S4: etching the second thin film layer 12 by taking the first mask layer as a mask, so that the second thin film layer 12 forms a second mask layer.

The second thin film layer 12 may be dry etched using plasma to form a second mask layer by the second thin film layer 12. For example, the second thin film layer 12 is etched using CF₄ as an etching gas.

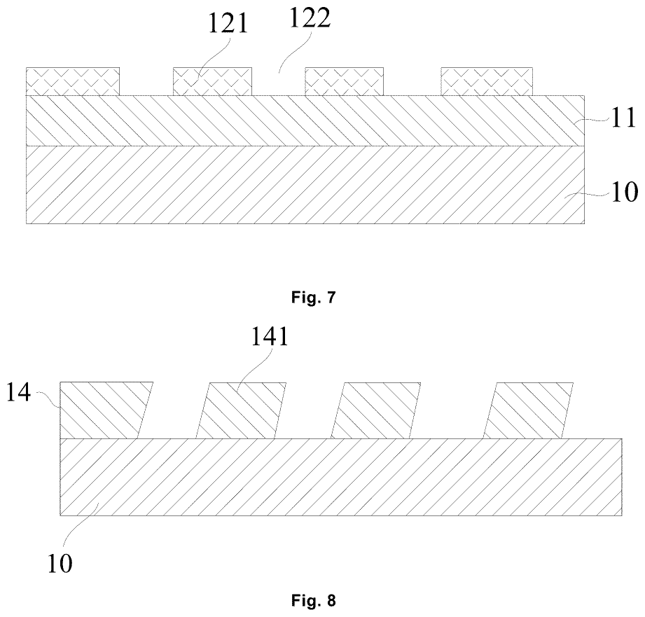

As shown in FIG. 7, the second mask layer includes a first mask layer having a plurality of second light-transmitting openings 122 and a plurality of second mask bosses 121 separating the plurality of second light-transmitting openings 122.

Step S5: removing the first mask layer, and etching the first thin film layer 11 using the second mask layer as a mask, so that the first thin film layer 11 forms a grating layer 14, wherein the grating layer 14 comprises a plurality of skewed tooth gratings 141, the slant angles of all the skewed tooth gratings 141 relative to the substrate 10 are equal, and the heights of all the skewed tooth gratings 141 are equal.

The first mask layer is removed, and the first thin film layer 11 is etched using the second mask layer as a mask, so that the structure of the grating layer 14 formed on the first thin film layer 11 is as shown in FIG. 8.

The first mask layer may be removed using O₂ plasma, and the first thin film layer 11 may be obliquely etched using a reactive ion beam with the second mask layer as a mask to form the grating layer 14. Optionally, the first thin film layer 11 may be etched using Cl₂ or CF₄ as an etching gas.

The slant angle of the reactive ion beam with respect to the substrate 10 is equal to the slant angle of the skewed tooth grating 141 of the grating layer 14 with respect to the substrate 10.

The slant angle of the reactive ion beam with respect to the substrate 10 may be 25-50 degrees, and the slant angle of the skewed tooth grating 141 with respect to the substrate 10 is 25-50 degrees.

The tilt directions of all the skewed tooth gratings 141 of the grating layer 14 are the same.

The grating layer 14 may have skewed tooth gratings 141 with different shapes. The heights of all the skewed tooth gratings 141 of the grating layer 14 are equal to the thickness of the first thin film layer 11, that is, the thickness of the grating layer 14 is equal to the thickness of the first thin film layer 11.

The height of the skewed tooth grating 141 refers to the height of the skewed tooth grating 141 in a direction perpendicular to the substrate 10. The height of the skewed tooth grating 141 can be 0.05-0.5 μm.

The refractive index of all the skewed tooth gratings 141 of the grating layer 14 is equal to the refractive index of the first thin film layer 11, that is, the refractive index of the grating layer 14 is equal to the refractive index of the first thin film layer 11.

Step S6: removing the second mask layer, and forming an optical waveguide including the grating layer 14 and the substrate 10.

Specifically, the second mask layer may be removed by wet etching, and the grating layer 14 and the substrate 10 are remained.

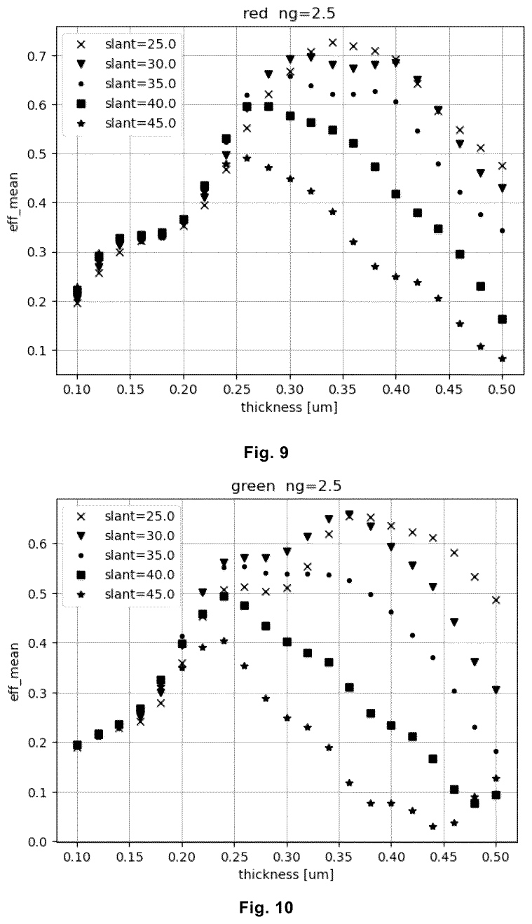

FIG. 9 is a schematic diagram of the diffraction efficiency of red light provided by an embodiment of the present disclosure. “Red” in FIG. 9 refers to red light, and “ng=2.5” represents that the refractive index of the grating layer is 2.5.

In a first alternative embodiment, as shown in FIG. 9, when the refractive index of the grating layer 14 is 2.5, the diffraction efficiency of red light can be made to be greater than 36% by making the height of the skewed tooth grating 141 of the grating layer 14 between 0.2-0.35 μm and making the slant angle of the skewed tooth grating 141 of the grating layer 14 be 45 degrees; and when the refractive index of the grating layer 14 is 2.5, the diffraction efficiency of red light can be made 50% by making the height of the skewed tooth grating 141 of the grating layer 14 be 0.26 μm and making the slant angle of the skewed tooth grating 141 of the grating layer 14 be 45 degrees.

In a second alternative embodiment, as shown in FIG. 9, when the refractive index of the grating layer 14 is 2.5, the diffraction efficiency of red light can be made to be greater than 36% by making the height of the skewed tooth grating 141 of the grating layer 14 between 0.2 and 0.42 μm and making the slant angle of the skewed tooth grating 141 of the grating layer 14 be 40 degrees; and when the refractive index of the grating layer 14 is 2.5, the diffraction efficiency of red light can be made 60% by making the height of the skewed tooth grating 141 of the grating layer 14 be 0.28 μm and making the slant angle of the skewed tooth grating 141 of the grating layer 14 be 40 degrees.

In a third alternative embodiment, as shown in FIG. 9, when the refractive index of the grating layer 14 is 2.5, the diffraction efficiency of red light can be made to be greater than 36% by making the height of the skewed tooth grating 141 of the grating layer 14 between 0.2 and 0.5 μm and making the slant angle of the skewed tooth grating 141 of the grating layer 14 be 35 degrees; and when the refractive index of the grating layer 14 is 2.5, the diffraction efficiency of red light can be made 68% by making the height of the skewed tooth grating 141 of the grating layer 14 be 0.28 μm and making the slant angle of the skewed tooth grating 141 of the grating layer 14 be 35 degrees.

In the fourth alternative embodiment, as shown in FIG. 9, when the refractive index of the grating layer 14 is 2.5, the diffraction efficiency of red light can be made 70% by making the height of the skewed tooth grating 141 of the grating layer 14 be 0.35 μm and making the slant angle of the skewed tooth grating 141 of the grating layer 14 be 30 degrees.

In a fifth alternative embodiment, as shown in FIG. 9, when the refractive index of the grating layer 14 is 2.5, the diffraction efficiency of red light can be made 72% by making the height of the skewed tooth grating 141 of the grating layer 14 be 0.35 μm and making the slant angle of the skewed tooth grating 141 of the grating layer 14 be 25 degrees.

It should be noted that, in this embodiment, when the refractive index of the grating layer 14 is greater than 2, the structure of the grating layer 14 of the optical waveguide is optimized by adjusting the slant angle and the thickness of the skewed tooth grating 141 of the grating layer 14. That is, when the refractive index of the grating layer 14 is greater than 2, the diffraction efficiency of red light can be greater than 36% by adjusting the slant angle and the thickness of the grating layer 14.

The embodiment of the present disclosure provides a method for manufacturing an optical waveguide, by forming the first thin film layer 11 with a refractive index greater than 2 on the substrate 10, and etching the first thin film layer 11 to form the grating layer 14 by the first thin film layer 11, it is possible to make the refractive index of the grating layer 14 greater than 2 and abandon the nanoimprint lithography glue. Therefore, the diffraction efficiency of light of a specific color can be improved by optimizing the structure of the grating layer 14 of the optical waveguide, and then the brightness of light of a specific color can be increased. For example, when the light of a specific color is red, the diffraction efficiency of red light can be made to be greater than 36%, thereby can improve the brightness of red light.

Optionally, in step S1, the method includes: providing a substrate 10 with a cleaned surface.

Optionally, after step S6, the method further includes: cleaning the grating layer 14 and the substrate 10.

Optionally, the second thin film layer 12 is a Cr film layer, and the thickness of the second thin film layer 12 is 10-100 nm. The substrate 10 is a glass substrate, the thickness of the substrate 10 is 0.3-3 mm, and the refractive index of the substrate 10 is 2.

Optionally, the first thin film layer 11 is a TiO₂ film layer, the thickness of the TiO₂ film layer is 0.35 μm, and the refractive index of the TiO₂ film layer is 2.5.

Wherein the heights of all the skewed tooth gratings 141 of grating layer 14 are 0.35 μm, and the slant angles of all the skewed tooth gratings of grating layer are 30 degrees.

Since the refractive index of all the skewed tooth gratings 141 of the grating layer 14 is equal to the refractive index of the first thin film layer 11, the refractive index of all the skewed tooth gratings 141 of the grating layer 14 is 2.5, that is, the refractive index of the grating layer 14 is 2.5.

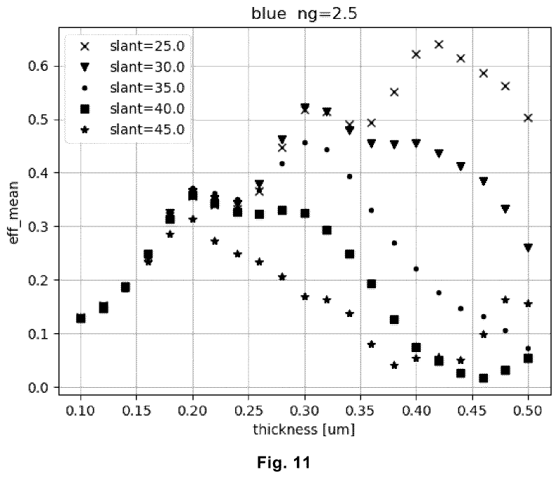

FIG. 10 is a graph showing the diffraction efficiency of green light provided by an embodiment of the present disclosure. FIG. 11 is a schematic diagram of diffraction efficiency of blue light provided by an embodiment of the present disclosure. “Green” in FIG. 10 represents green light, and “ng=2.5” represents that the refractive index of the grating layer is 2.5. In FIG. 11, “blue” represents blue light, and “ng=2.5” represents that the refractive index of the grating layer is 2.5.

As shown in FIGS. 9 to 11, when the refractive index of the grating layer 14 is 2.5, by making the height of the skewed tooth grating 141 of the grating layer 14 be 0.35 μm and making the slant angle of the skewed tooth grating 141 of the grating layer 14 be 30 degrees, the diffraction efficiency of red light can be 70%, the diffraction efficiency of green light can be 65%, and the diffraction efficiency of blue light can be 50%, and the diffraction efficiencies of red light, green light, and blue light can be balanced, thereby satisfying the requirement of full-color AR display.

As shown in FIG. 8, an embodiment of the present disclosure further provides an optical waveguide, including a substrate 10 and a grating layer 14, wherein the grating layer 14 is disposed on the substrate 10, and the grating layer 14 includes a plurality of skewed tooth gratings 141, the slant angles of all the skewed tooth gratings 141 relative to the substrate 10 are equal, and heights of all the skewed tooth gratings 141 are equal.

Wherein the optical waveguide is obtained by the method for manufacturing the optical waveguide in the embodiment.

The slant angle of the skewed tooth grating 141 relative to the substrate 10 may be 25-50 degrees. The height of the skewed tooth grating 141 refers to the height of the skewed tooth grating 141 in a direction perpendicular to the substrate 10. The height of the skewed tooth grating 141 can be 0.05-0.5 μm.

The refractive index of all the skewed tooth gratings 141 of the grating layer 14 is greater than 2, that is, the refractive index of the grating layer 14 is greater than 2. In some examples, the refractive index of grating layer 14 is greater than 2 and less than or equal to 3. With this arrangement, by optimizing the structure of the grating layer 14 of the optical waveguide, the diffraction efficiency of light of a specific color can be improved, and thus the brightness of light of the specific color can be improved. For example, when the light of a specific color is red, the diffraction efficiency of red light can be made greater than 36%, and thus the brightness of red light can be improved.

Finally, it should be noted that the above embodiments are only used for illustrating the technical solutions of the embodiments of the present disclosure, and not for limiting the same. Although embodiments of the present disclosure have been described in detail with reference to the foregoing embodiments, those of ordinary skill in the art will understand that the technical solutions described in the foregoing embodiments may still be modified, or some or all of the technical features may be equivalently replaced; and these modifications or substitutions do not depart from the scope of the embodiments of the present disclosure by the essence of the corresponding technical solutions.

What is claimed is:

1. A method for manufacturing an optical waveguide, comprising:
providing a substrate;
forming a first thin film layer, a second thin film layer and a sacrificial layer on the substrate in a stacked manner, wherein a refractive index of the first thin film layer is larger than 2;
exposing and developing the sacrificial layer so that the sacrificial layer forms a first mask layer;
etching the second thin film layer by taking the first mask layer as mask so that the second thin film layer forms a second mask layer;
removing the first mask layer, and etching the first thin film layer by taking the second mask layer as mask so that the first thin film layer forms a grating layer, wherein the grating layer comprises a plurality of skewed tooth gratings, slant angles of all the skewed tooth gratings relative to the substrate are equal, and heights of all the skewed tooth gratings are equal; and
removing the second mask layer to form the optical waveguide comprising the grating layer and the substrate.

2. The method for manufacturing an optical waveguide according to claim 1, wherein the step of removing the first mask layer, and etching the first thin film layer by taking the second mask layer as mask so that the first thin film layer forms a grating layer comprises:
removing the first mask layer using 02 plasma; and
obliquely etching the first thin film layer using a reaction ion beam by taking the second mask layer as mask so as to form the grating layer.

3. The method for manufacturing an optical waveguide according to claim 2, wherein slant angle of the reactive ion beam with respect to the substrate is 25-50 degrees.

4. The method for manufacturing an optical waveguide according to claim 1, wherein a thickness of the first thin film layer is 0.05-0.5 μm, and a height of the skewed tooth grating is 0.05 to 0.5 μm.

5. The method for manufacturing an optical waveguide according to claim 4, wherein the first thin film layer is a TiO₂ film layer, a thickness of the TiO₂ film layer is 0.35 μm, and a refractive index of the TiO₂ film layer is 2.5; and
the slant angle of the skewed tooth grating is 30 degrees, the height of skewed tooth grating is 0.35 μm.

6. The method for manufacturing an optical waveguide according to claim 1, wherein a method for forming the first thin film layer and the second thin film layer is physical vapor deposition.

7. The method for manufacturing an optical waveguide according to claim 6, wherein a method for manufacturing the sacrificial layer comprises:
spin coating photoresist on the second thin film layer to form the sacrificial layer.

8. The method for manufacturing an optical waveguide according to claim 1, wherein the step of etching the second thin film layer by taking the first mask layer as mask so that the second thin film layer forms a second mask layer comprises:
dry etching the second thin film layer using plasma by taking the first mask layer as mask so that the second thin film layer forms the second mask layer.

9. The method for manufacturing an optical waveguide according to claim 1, wherein the step of removing the second mask layer to form the optical waveguide comprising the grating layer and the substrate comprises:
removing the second mask layer using wet etching.

10. The method for manufacturing an optical waveguide according to claim 1, wherein in the step of providing a substrate, the method comprises:
providing the substrate with a cleaned surface.

11. The method for manufacturing an optical waveguide according to claim 1, further comprising, after the step of removing the second mask layer to form the optical waveguide comprising the grating layer and the substrate, the method further comprises:
cleaning the grating layer and the substrate.

12. An optical waveguide comprising a substrate and a grating layer, the grating layer is disposed on the substrate and comprises a plurality of skewed tooth gratings, slant angles of all the skewed tooth gratings relative to the substrate are equal, and heights of all the skewed tooth gratings are equal; and
refractive index of the grating layer is greater than 2.

13. The optical waveguide of claim 12, wherein the refractive index of the grating layer is less than or equal to 3;
the slant angle of the skewed tooth grating relative to the substrate is 25-50 degrees;
the height of the skewed tooth grating is 0.05-0.5 μm.
